(19) United States
(12) Patent Application Publication
(10) Pub. No.: US 2003/0171127 A1
(43) Pub. Date: Sep. 11, 2003

(54) Remote control/cordless telephone

(76) Inventor: Robert Louis Stevenson White, Austell, GA (US)

Correspondence Address: Robert Louis Stevenson White, 5137 Lake View Ct, Austell, GA, 30106, US

(21) Appl. No.: 10/087,805

(22) Filed: Mar. 5, 2002

(51) Int. Cl. H04Q 7/20

(52) U.S. Cl. 455/462; 455/465

(57) ABSTRACT

A device that would allow you be a remote control to your television, satellite, cable or vcr and be a cordless telephone all at the same time. The device will allow the function of ringing and answering inbound calls and dialing of outbound members. It will also have the capabilities such as memory dialing, redial and other channels controls.

### CROSS-REFERNECE TO REALTED APPLICATIONS

Not applicable

### STATEMENT REGARDING FEDERALLY SPONSERED RESEARCH OR DEVELOPMENT

Not applicable

### REFERENCE TO A MICROFICHE APPENDIX

Not applicable

### BACKGROUND OF THE INVENTION

The invention relates to the cordless telephone and remote control. The device will have a base unit, certain remote control functions and telephone features. This device will operate by mashing the on/off button, from there you will have the option to use the remote for the television or the telephone.

Once the television is mashed you can always have the option to do an outbound call or receive an inbound call. The outbound call can be made by simply hitting the phone button feature and dial from the key pad to enter the phone number, while still looking at television. A inbound call can be received just by either hitting the phone feature again or by picking up the remote from the base unit.

The device can also be used without the use of the television be on, at this time the remote can be used as a cordless telephone.

### BRIEF SUMMARY OF THE INVETION

In a brief summarized form, the claimed invention has its advantages. The number one advantage of this invention has be that you can receive an inbound or outbound call while using the remote control, to a television, vcr, dvd player or satellite all at the same time.

Unlike having a remote control for vcr, another for satellite, another for Dvd Player and another for cable features we now have what's called a universal remote control that can handle all of the device mentioned above all in one remote control. Now we have the claimed invention that will allow you to do all of that above and have telephone use too.

### BRIEF DESCRIPTION OF THE SEVERAL VIEWS OF THE DRAWING

FIG. 1. is an overview of the remote control cordless telephone

FIG. 2. is a simplified diagram of one embodiment of the invention (the control Channels)

FIG. 3. is a diagram of the keypad and phone side of the invention

FIG. 4. is a diagram of the outer face of the invention

FIG. 5. is a diagram of the side view of the invention

FIG. 6. is a diagram of the bottom view of the keypad and phone side

FIG. 7. is a diagram of the one embodiment of the invention

FIG. 8. is a simple diagram of the base unit of the invention

FIG. 9. is a diagram of one embodiment of the said invention

### DETAILED DESCRIPTION OF THE INVENTION

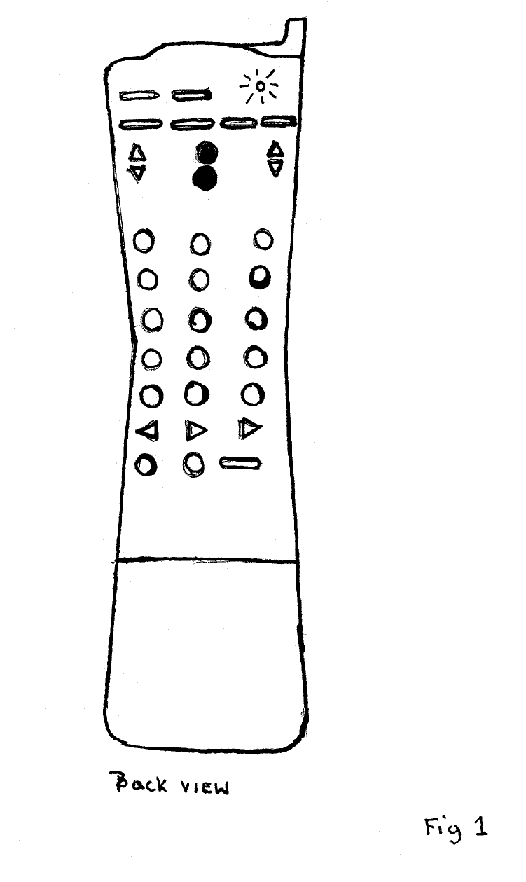

As shown in FIG. 1 in the drawings, shows a standard cordless telephone that is modified only to be a remote control to your television at the same time of being a telephone to receive inbound or outbound calls.

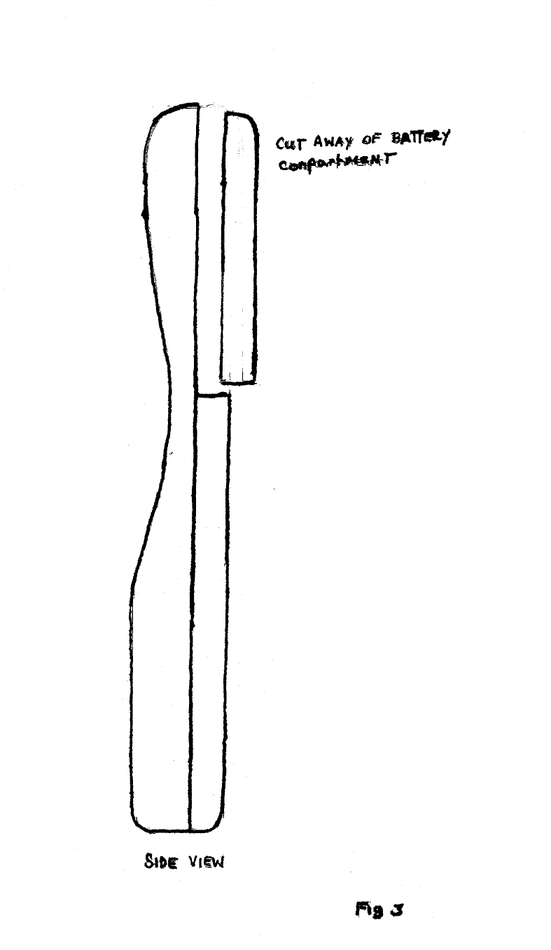

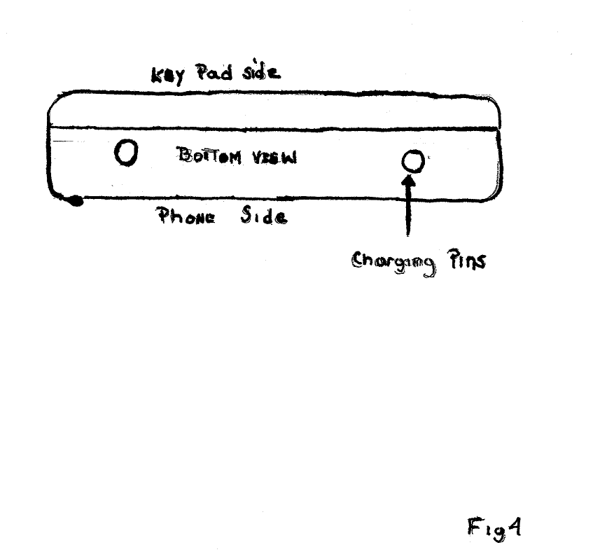

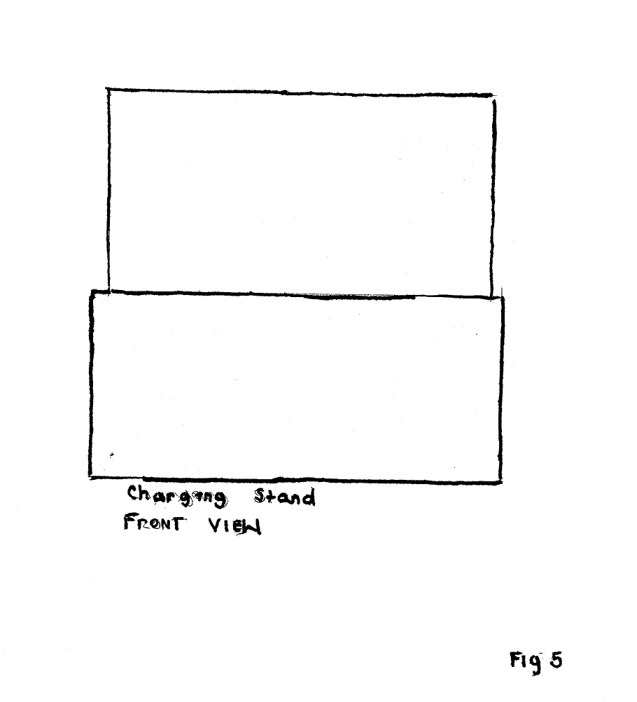

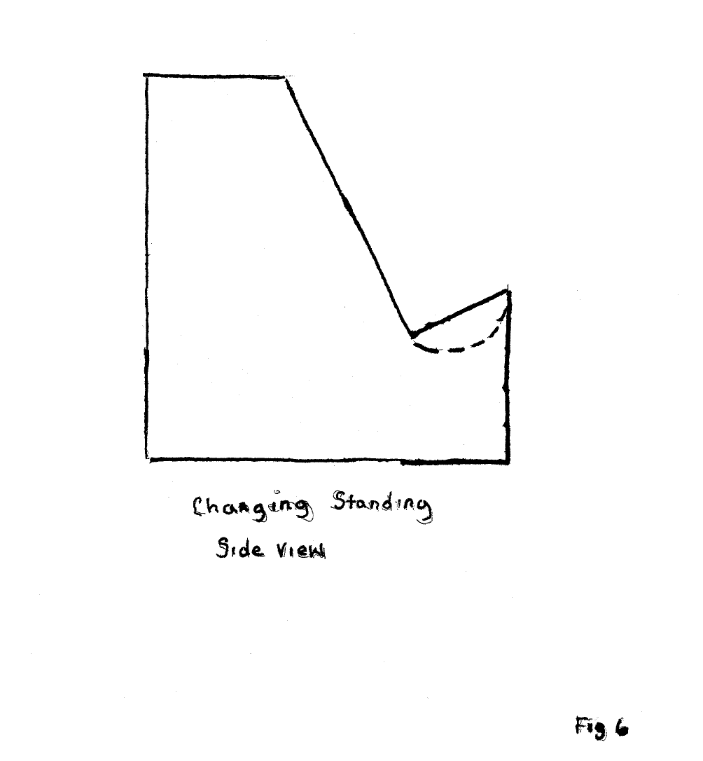

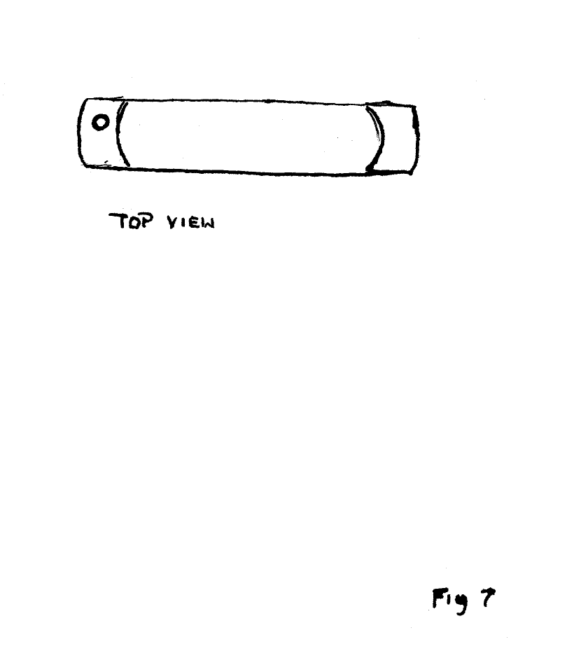

The claimed invention will have a base unit or some call it a charger. This base unit will charge the remote control cordless telephone so that it can be cordless at times. The invention will use AA batteries for the remote and a standard cordless telephone battery for the phone side. This invention will have and outer face that shows in FIG. 3, that you can hold up to your ear and actually hear inbound calls. On the other hand, it will also have a mouth piece where you can talk into and the other party will hear you just like a telephone. On this sane side you will see a feature called the caller id that will display name, time, date, and number of the person that is calling you.

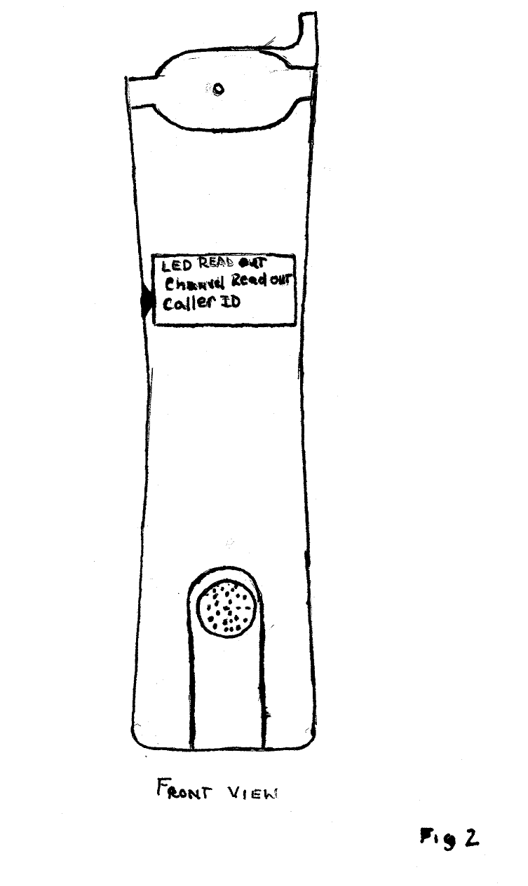

The invention as shown in FIG. 2 will have the control panels that include all features of the invention. The panels for the TV mode such as on/off switch for TV, volume, up/down for channels, mute and the indicator mode that programs the remote to your television. The panels for the telephone mode includes the numbers that you use to dial outbound calls. The panels for the vcr, dvd player which includes the rewind, fast forward, stop, play and pause functions.

What is claim as my invention:

1. a remote control cordless telephone device comprising: a remote control cordless telephone comprising of a remote control cordless base unit, it is said, the remote control cordless telephone comprising of a remote control, speaker, dial pad, the remote control will serve as the receiver for the communication.

2. A device as in claim 1 having an effective range between the base unit and said the remote telephone of no more than 500 ft.

3. A device as in claim 1 the said remote control cordless telephone will comprise of a ring and or color signal that will relay a sound.

4. A device as in claim 1 can be programmed to any television, vcr, dvd player, cable or satellite providing that it can be programmed to any remote control.
